(19) United States
(12) Patent Application Publication
(10) Pub. No.: US 2020/0131401 A1
(43) Pub. Date: Apr. 30, 2020

(54) THERMALLY CONDUCTIVE, ELECTRICALLY INSULATING COATING FOR WIRES

(71) Applicant: SABIC GLOBAL TECHNOLOGIES B.V., Bergen op Zoom (NL)

(72) Inventors: Yuming XIE, Lexington, KY (US); Ihab ODEH, Sugar Land, TX (US); Sreekanth PANNALA, Sugar Land, TX (US)

(21) Appl. No.: 16/626,931

(22) PCT Filed: Jun. 29, 2018
(86) PCT No.: PCT/US2018/040230

§ 371 Date: Dec. 27, 2019

Related U.S. Application Data
(60) Provisional application No. 62/527,624, filed on Jun. 30, 2017.

(51) Int. Cl. C09D 179/08; C09D 181/08

(52) U.S. Cl. CPC C09D 179/08; C09D 181/08; C08K 2003/382; C08L 2201/00; C08L 2203/202

(57) ABSTRACT

A coating composition comprises: exfoliated boron nitride nano sheets (BNNS); and a thermoplastic polymer matrix, wherein the coating composition: (i) has a thermal conductivity greater than or equal to 1.0 W/mK; (ii) has an electric breakdown voltage higher than or equal to 20 kV/mm; and (iii) is pliable. The coating composition can also include the exfoliated BNNS bound to the surfaces of a plurality of co-particles that aligns a plane of the BNNS not parallel to a longitudinal axis of an electromagnetic wire. The non-parallel alignment increases thermal conductivity through the coating. The polymer matrix can be a polyester imide, a polyamide-imide, polysulfones, a polyimide, a polyether ketone, or combinations thereof. Methods of forming the coating include forming the exfoliated BNNS; combining a first monomer and a second monomer to form the thermoplastic polymer matrix; and causing or allowing the exfoliated BNNS to be dispersed throughout the thermoplastic polymer matrix.

### TECHNICAL FIELD

Thermally conductive and electrically insulating materials can be used as a coating on electromagnetic wires. The materials can include boron nitride nano sheets dispersed in a polymer matrix that are thermally conductive and electrically insulating.

### BRIEF DESCRIPTION OF THE FIGURES

The features and advantages of certain embodiments will be more readily appreciated when considered in conjunction with the accompanying figures. The figures are not to be construed as limiting any of the preferred embodiments.

FIG. 1 is a graph of thermal conductivity in units of watts per meter-Kelvin (W/mK) versus boron nitride filler volume fraction in units of volume percent (v %).

FIG. 2 is a schematic of a composite coating for an electromagnetic wire according to certain embodiments.

### DETAILED DESCRIPTION

An electromagnetic coil includes an electrical conductor, such as a wire, wound in various configurations of a coil, spiral, or helix. Electromagnetic coils can be used in devices such as electric motors, inductors, electromagnets, transformers, and sensor coils. Either an electric current is passed through the wire of the coil to generate a magnetic field, or conversely an external time-varying magnetic field through the interior of the coil generates voltage within the conductor. Thermally conductive and electrically insulating polymeric materials are highly desirable for coating the wires of electromagnetic coils. The coating should possess a desirably high thermal conductivity, high pliability, and low electrical conductivity.

Removing heat from the electric coils by thermal conduction has been proven to make these devices operate more efficiently, at higher outputs, or provide longer service life. Conventional coating materials are typically polymer composites with ceramic as a filler due to the low thermal conductivity of polymers. The ceramic materials, especially non-oxides, are generally better thermal conductors than the polymer composites due to their crystalline structure and the characteristics of chemical bonds. In order to improve the thermal conductivity of the polymer, the typical volume fraction of filler needs to be 50 volume percent (v %) of the polymer or higher. However, issues can arise with such a high concentration of filler for example, the polymer coating's pliability suffers greatly as the concentration of filler increases.

The thermal conductivity of a material includes two components—electric conduction and phonon transport. As a dielectric material, organic polymers conduct heat through either propagation of anharmonic elastic waves in the continuum or the interaction between quanta of thermal energy called phonons. The major process that gives rise to a finite thermal conductivity and energy dissipation from thermal elastic waves is phonon-phonon interaction corresponding to phonon scattering. In addition to phonon-phonon interactions, limited lattice frameworks in the polymer system give significant rise to anharmonicities and results in high phonon scattering, which shortens the free-mean path the phonons are able to travel. This reduction in the free-mean path of the phonons thereby reduces thermal conductivity. As a result, some polymers possess a low thermal conductivity, generally in a range of 0.1 to about 0.5 watts per meter-Kelvin (W/m·K), mainly as a result from the random structure of the polymers.

In order to improve the thermal conductivity of polymers, one common approach is to add a thermally conductive ceramic powder, commonly called thermal conductive filler. The thermal conductivity of ceramic-polymer composites generally increases very shallowly with increased concentration of the ceramics. Only when the concentration reaches the percolation limit of about 70 v %, can significant thermal conductivity increases materialize. The thermal conductivity in such a case can be increased by almost 50 times compared to lower filler concentrations, with a total thermal conductivity reaching above 10 W/mK. In addition to a high thermal conductivity, the coating should also be pliable to allow the wire to bend without causing the coating to break. However, with such a high ceramic loading, the polymer composites are not very pliable or flexible, so use as an enamel coating for electromagnetic wires is generally impractical or impossible.

In addition to a high thermal conductivity and pliability, the coating should also possess a low electrical conductivity; thereby, limiting electron transfer through the coating and increasing the electrical output of the coil. In another approach, more thermally conductive graphene or graphite has been used as fillers. The thermal conductivity with these fillers can be increased to 25 W/mK while keeping the polymer composite fairly flexible. However, the electrical conductivity is too high for use as an electrically insulating coating of electromagnetic wires due to the high electron mobility in graphene or graphite.

Other fillers have also been used to increase the thermal conductivity of a coating for wires. However, these other fillers also suffer from drawbacks of increased electrical conductivity, decreased pliability, or being too expensive. Thus, there is a need and an ongoing industry-wide concern for thermally conductive and electrically insulating compositions that can be used as a coating for electromagnetic wires.

It has been discovered that a thermally conductive and electrically insulating composition can be formed with boron nitride nano sheets dispersed within a thermally conductive polymer matrix. The composition can be used as a coating for wires. The concentration of the nano sheets can be less than other compositions, while still providing a desired thermal conductivity, electrical insulation, and pliability.

It is to be understood that the discussion of preferred embodiments regarding the composition is intended to apply to all of the composition and method embodiments.

According to certain embodiments, a coating composition comprises: exfoliated boron nitride nano sheets; and a thermoplastic polymer matrix, wherein the coating composition: (i) has a thermal conductivity greater than or equal to 1.0 W/mK; (ii) has an electric breakdown voltage higher than or equal to 20 kilovolts per millimeter (kV/mm); and (iii) is pliable.

According to certain other embodiments, a method of forming a coating composition comprises: forming exfoliated boron nitride nano sheets; combining a first monomer and a second monomer to form a thermoplastic polymer matrix; and causing or allowing the exfoliated boron nitride nano sheets to be dispersed throughout the thermoplastic polymer matrix, wherein the coating composition: (i) has a thermal conductivity greater than or equal to 1.0 W/mK; (ii) has an electric breakdown voltage higher than or equal to 20 kV/mm; and (iii) is pliable.

The coating composition can be used to coat an electromagnetic wire. The electromagnetic wire can be part of an electromagnetic coil that is used in electric motors, inductors, electromagnets, transformers, and sensor coils for example. An electrical current can pass through the wire. A typical current for such a wire can be 20 kilowatts per millimeter (kW/mm) or greater.

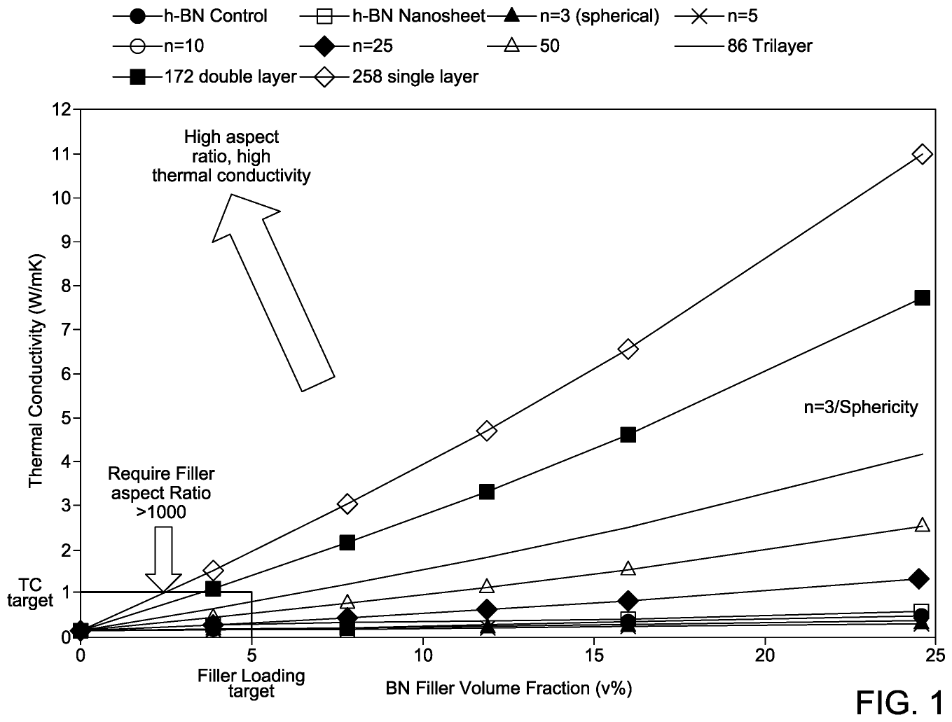

The coating composition includes exfoliated boron nitride nano sheets (BNNS). Boron nitride powder can be exfoliated into nano sheets, which can range from a single layer to several layers. BNNSs may be obtained by overcoming the forces of attraction between neighboring layers of within the structure of the boron nitride powder (such as those in hexagonal boron, h-BN, for example). The thickness distributed depends on the exfoliation process conditions. FIG. 1 presents a modeling simulation of the thermal conductivity as a function of boron nitride volume fraction. With respect to FIG. 1, h-BN control is a bulk h-BN; h-BN nanosheet is an atom- (or several atoms) thin sheet of h-BN; n is the particle shape factor—where 3 represents a sphere and higher values represents flatter and longer dimensions. The layers represent the number of layers in each nanosheet.

As can be seen in FIG. 1, the single layer nano sheets (n=258, “258 single layer”) provide the highest thermal conductivity at the same concentration compared to double or multi-layer nano sheets. As the layers of nano sheets thicken, the thermal conductivity improvement drops precipitously. According to certain other embodiments, the BNNS provide a thermal conductivity of at least 1 watt per meter Kelvin (W/mK). Accordingly, the concentration of the exfoliated boron nitride nano sheets can be selected to provide a thermal conductivity greater than or equal to 1 W/mK. The concentration of the exfoliated boron nitride nano sheets can also be selected to provide the desired amount of pliability for the coating. According to certain embodiments, the exfoliated boron nitride nano sheets are in a concentration in the range of about 1% to about 25% by volume of the coating composition, depending on the thickness of dispersed BNNS in the polymer matrix.

The methods include forming exfoliated boron nitride nano sheets. As used herein, “exfoliated boron nitride nano sheets” means boron nitride in the form of a sheet (i.e., a flat artifact that is thin relative to its length and width), with length and width dimensions in the range of about 10 to about 5,000 nanometers (nm) and a height in the range of about 0.33 to about 3 nm, and ranging from a monolayer (i.e., a single sheet) or multi-layer sheets. The exfoliated boron nitride nano sheets can have an average thickness of less 10 molecular layers, preferable less than 5 monolayers. The exfoliated boron nitride nano sheets can have an aspect ratio (average diameter in x, y direction to average thickness of the nano sheets) greater than 350, preferably greater than 500. The exfoliated boron nitride nano sheets can be formed by any suitable method known to those skilled in the art. An illustrated example of formation of the exfoliated boron nitride nano sheets can include dispersing boron nitride powder in a polar organic solvent such as N-methylpyrrolidone (NMP), dimethylformamide (DMF), dimethylacetamide (DMAc), dimethyl sulfoxide (DMSO), isopropanol, etc. The slurry is then pumped through a wet jet mill for exfoliation. The slurry can be pressurized at a sufficient pressure (e.g., up to 36,000 pounds force per square inch (psi)) and then released to a single nozzle chamber to form the exfoliated boron nitride nano sheets. It is to be understood that not all of the boron nitride powder may form exfoliated boron nitride nano sheets. Accordingly, the slurry can be cycled as many times as needed to achieve a desired percent conversion. According to certain embodiments, the desired percent conversion is at least 30%, more preferably at least 50% or greater. The exfoliated boron nitride nano sheets can be separated from the polar organic solvent via centrifugation, for example, at revolutions per minute (rpm) in the range of about 5,000 to about 15,000 and a time in the range of about 30 minutes to about 5 hours.

The methods can further include oxidizing the surface of boron nitride (BN) powder prior to the step of forming the exfoliated boron nitride nano sheets. The BN powder can be oxidized, for example, by mixing boron nitride powder, having a particle size of about 0.1 to about 10 micrometers (μm) with a hydrogen peroxide solution, which is a known process for forming hydroxyl groups on the surface of the boron nitride powder. After stirring for a desired period of time, preferably at room temperature, the slurry is filtered and washed with water under vacuum. The powder can be dried in a vacuum oven at approximately 120° C. for a period of time and then exfoliated.

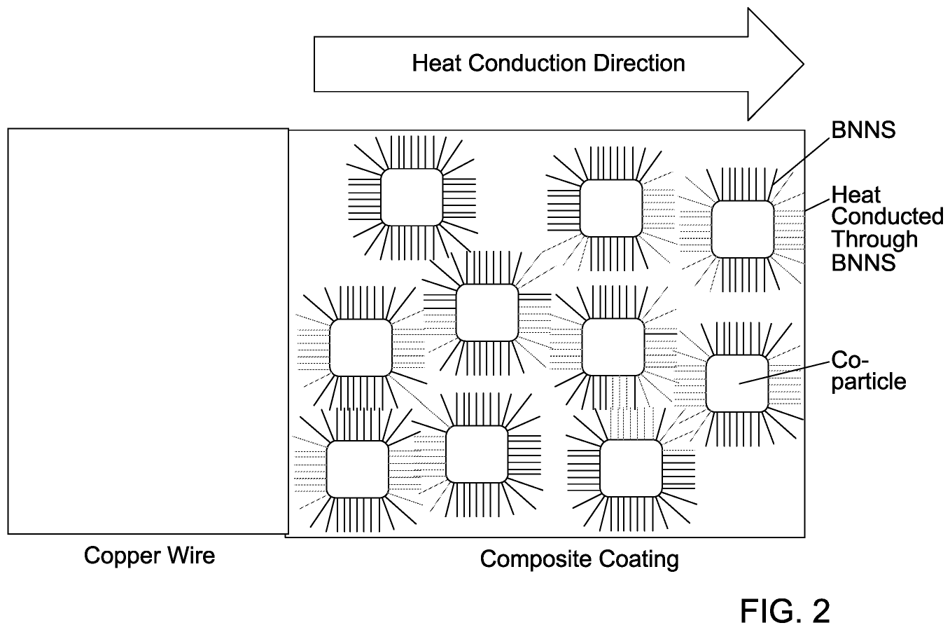

The methods can further include adding a stabilizer during the step of exfoliating the boron nitride nano sheets. The stabilizer can help keep the monolayer nano sheets separated and suspended without recombination into multi-layer stacks of sheets. According to certain embodiments, the stabilizer is a diamine. Examples of suitable stabilizers include, but are not limited to, 4,4′-methylenedianiline and ethylene diamine. The stabilizer can chemically react with and form bonds (including hydrogen bond) on functional groups at the edges of the exfoliated boron nitride nano sheets to separate and disperse the BNNS in solution. The diamine stabilizer can also be a first monomer for forming the polymer matrix. The stabilizer can also help form bridges between the edges of the exfoliated boron nitride nano sheets. These bridges can help increase heat transfer away from the wire, for example, as shown in FIG. 2.

A polymer is a large molecule composed of repeating units, typically connected by covalent chemical bonds. A polymer is formed from monomers. During the formation of the polymer, some chemical groups can be lost from each monomer. The piece of the monomer that is incorporated into the polymer is known as the repeating unit or monomer residue. The backbone of the polymer is the continuous link between the monomer residues. The polymer can also contain functional groups connected to the backbone at various locations along the backbone. Polymer nomenclature is generally based upon the type of monomer residues comprising the polymer. A polymer formed from one type of monomer residue is called a homopolymer. A copolymer is formed from two or more different types of monomer residues. The number of repeating units of a polymer is referred to as the chain length of the polymer. The number of repeating units of a polymer can range from approximately 11 to greater than 10,000. In a copolymer, the repeating units from each of the monomer residues can be arranged in various manners along the polymer chain. For example, the repeating units can be random, alternating, periodic, or block. The conditions of the polymerization reaction can be adjusted to help control the average number of repeating units (the average chain length) of the polymer.

A polymer has an average molecular weight, which is directly related to the average chain length of the polymer. The average molecular weight of a polymer has an impact on some of the physical characteristics of a polymer, for example, its solubility and its dispersibility. For a copolymer, each of the monomers will be repeated a certain number of times (number of repeating units). The average molecular weight (M_{w}) for a copolymer can be expressed as follows:

M_{w}=ΣwₓMₓ

where wₓ is the weight fraction of molecules whose weight is Mₓ.

During a coating extrusion process, a plane of the BNNS typically align parallel to a longitudinal axis of the electromagnetic wire. This parallel alignment however, decreases heat flow through the coating composition in a direction away from the wire. Accordingly, the coating composition can further include a plurality of co-particles, wherein a first edge of the exfoliated boron nitride nano sheets is bound to the surface of the co-particle. This embodiment can be seen in FIG. 2. The exfoliated boron nitride nano sheets do not have to chemically bond with the surfaces of the co-particles, but preferably form bonds and attach to the surfaces of the co-particles. The co-particles, as seen in FIG. 2, can help orient a plane of some of the BNNS in a direction that is not parallel (i.e., at an angle between about 5° to 90°) to the longitudinal axis of the wire. These non-parallel orientations, along with the bridges formed between the sheets, can increase the heat conduction in a direction away from the wire.

The co-particles can be selected from the group consisting of boron nitride BN, boron carbide B₄C, aluminum nitride AlN, aluminum oxide Al₂O₃, silicon dioxide SiO₂, magnesium oxide MgO, silicon carbide SiC, silicon nitride Si₃N₄, zinc oxide ZnO, beryllium oxide BeO, diamond, metal oxides, titanium oxide, quartz, and other ceramics, and combinations thereof. According to certain embodiments, the co-particles are boron nitride powder or aluminum nitride powder. Aluminum nitride powder may not be used in applications with a high moisture content in the area as aluminum nitride can easily react with water.

The co-particles can be three-dimensional particles having a variety of geometric shapes including, but not limited to, spherical, cubical, hexagonal, triangular, or combinations thereof. The co-particles can also have a mean cross-sectional particle size in the range of about 0.2 μm to about 10 μm, or from about 0.5 μm to about 2 μm. In further examples, the co-particles can have a mean cross-sectional particle size in a range of any two values between those expressed, such as, for example, between 0.2 μm and 9 μm, 0.3 μm and 8 μm, 0.5 μm and 5 μm. According to certain embodiments, the co-particles are in a concentration in the range of about 1% to about 20% by volume of the composition. In further embodiments, the co-particles are in a concentration in the range of any two values between 1% to about 20%, such as, for example, between 1% and 15%, 1% and 10%, 1% and 5%, 1% and 8%, 1% and 12%, 3% and 20%, 3% and 15%, 3% and 10%, 3% and 12%, 5% and 20%, 5% and 15%, 5% and 18%, 10% and 20%, 10% and 15%, 10% and 18%.

The methods can further include performing a silane treatment on the dispersed exfoliated boron nitride nano sheets and the co-particles. A silane treatment can functionalize the edges of the exfoliated nano sheets and the co-particles wherein the edges and surfaces are amino treated. The silane treatment can help the boron nitride nano sheets bond to the surfaces of the co-particles or to act like a diamine monomer to polymerize with a second monomer. An illustrative silane treatment can include combining the exfoliated boron nitride nano sheets dispersed in the polar organic solvent with aminopropyltriethoxysilane (APS) under protection of flowing nitrogen, so the BNNS edges are amino-treated. The solution can be stirred in a 3-necked flask, equipped with a reflux condenser and a magnetic stir bar. The stirring solution can be heated to approximately 120° C. for 4 hours. The silane treatment can also functionalize other edges of the exfoliated boron nitride nano sheets that are not attached to the co-particles for bonding with functional groups of the polymer matrix. In this manner, the nano sheets obtain proper alignment, dispersion, and bridging to provide improved thermal conductivity through the coating composition.

The coating composition also includes a thermoplastic polymer matrix. According to certain embodiments, the exfoliated boron nitride nano sheets and the optional co-particles are dispersed throughout the polymer matrix. The polymer matrix can also help stabilize and keep the BNNS and optional co-particles suspended and separated within the matrix. The polymer matrix can be thermally conductive. The polymer can be a homopolymer or co-polymer. The first monomer can be selected from 4,4′-methylenedianiline and methylene diphenyl diisocyanate. The second monomer can be selected from dicarboxylic acid, dicarboxylic acid anhydride, alkyl ester, and other dicarboxylic acid derivatives. Any of the polymers can include two or more monomers or monomer residues, cross-linking agents, and/or functional groups on the polymer. Suitable functional groups and/or cross-linking agents include, but are not limited to, ethers, epoxides, amides, esters, and combinations comprising at least one of the foregoing.

According to certain embodiments, the thermoplastic polymer is thermally stable up to a temperature of 180° C. As used herein, the term “thermally stable” means that the polymer does not burn or degrade. According to this embodiment, the thermoplastic polymer is a polyimide, such as polyester imide (PEI) or poly(ester-imide-ether). As used herein, a “polyimide” refers to polymers comprising repeating imide functional groups, and optionally additional functional groups such as amides and/or ethers. PEI can be formed by polymerizing a first monomer of 4,4′-methylenedianiline, a second monomer of methyl trimellitic anhydride ester, and a third monomer of 4,4′-biphenol. The thermoplastic polymer can also be poly(ester-imide-ether) and formed by polymerizing dimethyl terephthalate (DMT) and N-(4-carbomethoxyphenyl)-4-(carbomethoxy)-phthalimide with ethylene glycol (EG) and polytetramethylene glycol (PTMG).

According to certain other embodiments, the thermoplastic polymer is thermally stable up to a temperature of 200° C. According to this embodiment, the polymer is polyamide-imide (PAI), polysulfones, or combinations thereof. PAI can be formed via an acid chloride route wherein condensation of an aromatic diamine, such as methylene dianiline (MDA), and an aromatic diacid chloride, such as trimellitic acid chloride (TMAC), terephthaloyl chloride, isophthaloyl chloride, or naphthoyl chloride, occurs. Reaction of the anhydride with the diamine produces an intermediate amic acid. The acid chloride functional group reacts with the aromatic amine to give the amide bond and hydrochloric acid (HCl) as a by-product. PAI can also be formed via a diisocyanate route wherein a diisocyanate, such as 4,4′-methylene diphenyl diisocyanate (MDI), is reacted with trimellitic anhydride (TMA). Polysulfones can be formed by condensing a diphenol, such as bisphenol-A, biphenol, or dihydroxy diphenyl ether with a dihalide containing sulfone groups, such as bis(4-chlorophenyl sulfone) or bis(4-chlorophenyl)sulfone, which forms a polyether by elimination of sodium chloride.

According to certain other embodiments, the thermoplastic polymer is thermally stable at a temperature greater than or equal to 240° C. According to this embodiment, the polymer is a polyimide (PI) or a polyether ketone. PI can be formed by polymerizing a first monomer of a dianhydride, such as pyromellitic dianhydride, benzoquinonetetracarboxylic dianhydride, bisphenol A dianhydride, napthyl dianhydride, or biphenyl dianhydride with a second monomer of a diamine, such as 4,4′-diaminodiphenyl ether (“DAPE”), meta-phenylenediamine (“MDA”), and 3,3-diaminodiphenylmethane. PI can also be formed by polymerizing the dianhydride with a second monomer of a diisocyanate, such as 4,4′-methylene diphenyl diisocyanate (MDI). Polyether ketones can be formed by step-growth polymerization by the dialkylation of bisphenolate salts, such as 4,4′-difluorobenzophenone with the disodium salt of hydroquinone. The polymerization can be carried out in a suitable polar aprotic solvent, such as diphenyl sulphone.

The methods include combining the first monomer and a second monomer (and optionally any other monomers) to form the thermoplastic polymer. As discussed above, the first monomer can be combined with the boron nitride powder and solvent prior to, during, or after formation of the exfoliated boron nitride nano sheets. The second monomer (and any other monomers) can be combined with the first monomer after formation of the exfoliated boron nitride nano sheets, for example, after a silane treatment, or during or after surface coupling of the BNNS to the co-particles. The monomers form the polymer via in situ polymerization; thus, maintaining separation and dispersion of the exfoliated boron nitride nano sheets or the exfoliated boron nitride nano sheets/co-particles in the resulting polymer matrix. The polymerization reaction can be controlled to provide a polymer with a desired molecular weight. The molecular weight of the polymer can be in the range of about 10,000 to about 100,000. The polymer can include linear or branched units and be arranged in random, alternating, periodic, or block configurations.

The coating composition has a thermal conductivity greater than or equal to 1.0 W/mK. According to certain embodiments, the polymer has an electric breakdown voltage that is sufficiently high to prevent the polymer from burning or degrading during the spikes in electric current flowing through the wire. The monomers selected, the thickness of the coating, and other characteristics of the polymer, such as molecular weight can be selected such that the polymer has the sufficient electric breakdown voltage. According to certain other embodiments, the coating composition also has an electric breakdown voltage less than or equal to 20 kilovolts per millimeter (kV/mm). A voltage differential between the wire and polymer matrix occurs when an electrical current passes through the electromagnetic wire. Accordingly, the polymer matrix should be able to withstand the voltage differential without burning or degrading. The polymer matrix can be electrically insulating (i.e., has an electrical conductivity less than or equal to 20 kV/mm) in order to inhibit or prevent movement of electrons through the polymer. The polymer's electrical conductivity and electric breakdown voltage are inversely related—the lower the conductivity, the higher the breakdown voltage.

The coating composition can further include an additive selected from the group consisting of primary antioxidants, secondary antioxidants, acid scavengers or neutralizers, UV absorbers/stabilizers, anti-blocking agents, slip agents, antistatic agents, antifogging agents, nucleating agents, coupling agents, cross-linking agents, controlled cracking agents, flame retardants, lubricants, and combinations thereof.

The methods can further include dip coating the coating composition onto an electromagnetic wire. The thermoplastic polymer can cure and harden with time and temperature. The methods can further include causing or allowing the coating composition to thermally cure after the step of dip coating. The time and temperature for curing can be selected for the specific polymer chosen for the thermoplastic polymer matrix.

The following are illustrated methods for preparing the exfoliated boron nitride nano sheets and co-particles. The following examples are not the only methods for producing the coating composition and are not intended to limit the scope of the various embodiments.

Formation of the exfoliated boron nitride nano sheets (BNNS) can be produced as follows:
(A) boron nitride powder (BN)-oxidized-silanation—removal of un-partially exfoliated BN powder by centrifugation;
(B) BN-oxidized, silanation after exfoliation—removal of un-partially exfoliated BN powder by centrifugation;
(C) BN, oxidation, silanation after exfoliation—removal of un-partially exfoliated BN powder by centrifugation;
(D) BN-oxidized-silanation—no removal of un-partially exfoliated BN powder, resulting in mixed BNNS plus BN powder;
(E) BN-oxidized, silanation after exfoliation—no removal of un-partially exfoliated BN powder, resulting in mixed BNNS plus BN powder;
(F) BN without treatment, oxidation, silanation after exfoliation—no removal of un-partially exfoliated BN powder, resulting in mixed BNNS plus BN powder.

Formation of the co-particles and BBNS to form a three-dimensional filler can be produced as follows:
(A) BN oxidize+silanation, exfoliate in absence of first monomer (e.g., diamine), centrifuge, BN powder oxidize+silanation, second monomer coupling;
(B) BN oxidize+silanation, exfoliate in absence of first monomer, without centrifugation, second monomer coupling with un-exfoliated BN powder;
(C) BN-oxidized-silanation—removal of un-partially exfoliated BN powder by centrifugation;
(D) BN-oxidized, silanation after exfoliation—removal of un-partially exfoliated BN powder by centrifugation;
(E) BN, oxidation, silanation after exfoliation—removal of un-partially exfoliated BN powder by centrifugation;
(F) BN-oxidized-silanation—no removal of un-partially exfoliated BN powder, resulting in mixed BNNS plus BN powder;
(G) BN-oxidized, silanation after exfoliation—no removal of un-partially exfoliated BN powder, resulting in mixed BNNS plus BN powder;
(H) BN, oxidation, silanation after exfoliation—no removal of un-partially exfoliated BN powder, resulting in mixed BNNS plus BN powder.

The present disclosure relates to at least the following aspects.

Aspect 1A. A coating composition comprising: exfoliated boron nitride nano sheets; and a thermoplastic polymer matrix, wherein the coating composition: (i) has a thermal conductivity greater than or equal to 1.0 W/mK; (ii) has an electric breakdown voltage greater than or equal to 20 kV/mm; and (iii) is pliable.

Aspect 1B. A coating composition consisting essentially of: exfoliated boron nitride nano sheets; and a thermoplastic polymer matrix, wherein the coating composition: (i) has a thermal conductivity greater than or equal to 1.0 W/mK; (ii) has an electric breakdown voltage greater than or equal to 20 kV/mm; and (iii) is pliable.

Aspect 1C. A coating composition consisting of: exfoliated boron nitride nano sheets; and a thermoplastic polymer matrix, wherein the coating composition: (i) has a thermal conductivity greater than or equal to 1.0 W/mK; (ii) has an electric breakdown voltage greater than or equal to 20 kV/mm; and (iii) is pliable.

Aspect 2. The coating composition according to any of Claims 1A-1C, wherein the exfoliated boron nitride nano sheets are in a concentration in the range of about 1% to about 25% by volume of the coating composition.

Aspect 3. The coating composition according to any of Claim 1A-1C, further comprising a plurality of co-particles, wherein a first edge of the exfoliated boron nitride nano sheets are bound to the surfaces of the co-particles.

Aspect 4. The coating composition according to Claim 3, wherein the co-particles are selected from the group consisting of BN, B₄C, AlN, Al₂O₃, SiO₂, MgO, SiC, Si₃N₄, ZnO, BeO, diamond, metal oxides, titanium oxide, quartz, ceramics, and combinations thereof.

Aspect 5. The composition according to Claim 3, wherein the co-particles are BN.

Aspect 6. The composition according to Claim 3, wherein the co-particles are in a concentration in the range of about 1% to about 20% by volume of the coating composition.

Aspect 7. The composition according to any of Claims 1A-1C, wherein the thermoplastic polymer is thermally stable up to a temperature of 180° C.

Aspect 8. The composition according to Claim 7, wherein the thermoplastic polymer is polyester imide.

Aspect 9. The composition according to any of Claims 1A-1C, wherein the thermoplastic polymer is thermally stable up to a temperature of 200° C.

Aspect 10. The composition according to Claim 9, wherein the thermoplastic polymer is polyamide-imide, polysulfones, or combinations thereof.

Aspect 11. The composition according to any of Claims 1A-1C, wherein the thermoplastic polymer is thermally stable at a temperature greater than or equal to 240° C.

Aspect 12. The composition according to Claim 11, wherein the thermoplastic polymer is a polyimide or a polyether ketone.

Aspect 13. The composition according to any of Claims 1A-1C, wherein the coating composition is coated onto an electromagnetic wire.

Aspect 14. The composition according to any of Claims 1A-1C, wherein the exfoliated boron nitride nano sheets have an average thickness of less 10 molecular layers and an aspect ratio greater than 350.

Aspect 15A. A method of forming a coating composition comprising: forming exfoliated boron nitride nano sheets; combining a first monomer and a second monomer to form a thermoplastic polymer matrix; and causing or allowing the exfoliated boron nitride nano sheets to be dispersed throughout the thermoplastic polymer matrix, wherein the coating composition: (i) has a thermal conductivity greater than or equal to 1.0 W/mK; (ii) has an electric breakdown voltage greater than or equal to 20 kV/mm; and (iii) is pliable.

Aspect 15B. A method of forming a coating composition consisting essentially of: forming exfoliated boron nitride nano sheets; combining a first monomer and a second monomer to form a thermoplastic polymer matrix; and causing or allowing the exfoliated boron nitride nano sheets to be dispersed throughout the thermoplastic polymer matrix, wherein the coating composition: (i) has a thermal conductivity greater than or equal to 1.0 W/mK; (ii) has an electric breakdown voltage greater than or equal to 20 kV/mm; and (iii) is pliable.

Aspect 15C. A method of forming a coating composition consisting of: forming exfoliated boron nitride nano sheets; combining a first monomer and a second monomer to form a thermoplastic polymer matrix; and causing or allowing the exfoliated boron nitride nano sheets to be dispersed throughout the thermoplastic polymer matrix, wherein the coating composition: (i) has a thermal conductivity greater than or equal to 1.0 W/mK; (ii) has an electric breakdown voltage greater than or equal to 20 kV/mm; and (iii) is pliable.

Aspect 16. The method according to any of Claims 15A-15C, further comprising oxidizing the surface of boron nitride powder prior to the step of forming the exfoliated boron nitride nano sheets.

Aspect 17. The method according to Claim 16, further comprising: adding the surface oxidized boron nitride powder to the first monomer and a solvent; then exfoliating the boron nitride nano sheets and performing a silane treatment on the exfoliated boron nitride nano sheets and first monomer; and then combining the second monomer with the exfoliated boron nitride nano sheets and first monomer.

Aspect 18. The method according to Claim 17, further comprising adding a plurality of co-particles after the step of combining the second monomer with the exfoliated boron nitride nano sheets and first monomer, and allowing the exfoliated boron nitride nano sheets to bond to the surfaces of the plurality of co-particles to form a filler.

Aspect 19. The method according to any of Claims 15A-15C, further comprising adding a plurality of co-particles before the step of combining the second monomer with first monomer, and allowing the exfoliated boron nitride nano sheets to bond to the surfaces of the plurality of co-particles to form a filler.

Aspect 20. The method according to any of Claims 15A-15C, further comprising dip coating the coating composition onto an electromagnetic wire.

Aspect 21. The method according to Claim 20, further comprising allowing the coating composition to thermally cure after the step of dip coating.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is, therefore, evident that the particular illustrative embodiments disclosed above may be altered or modified and all such variations are considered within the scope and spirit of the present disclosure.

As used herein, the words “comprise,” “have,” “include,” and all grammatical variations thereof are each intended to have an open, non-limiting meaning that does not exclude additional elements or steps. While compositions, systems, and methods are described in terms of “comprising,” “containing,” or “including” various components or steps, the compositions, systems, and methods also can “consist essentially of” or “consist of” the various components and steps. It should also be understood that, as used herein, “first,” “second,” and “third,” are assigned arbitrarily and are merely intended to differentiate between two or more phases, etc., as the case may be, and does not indicate any sequence. Furthermore, it is to be understood that the mere use of the word “first” does not require that there be any “second,” and the mere use of the word “second” does not require that there be any “third,” etc.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent(s) or other documents that may be incorporated herein by reference, the definitions that are consistent with this specification should be adopted.

Ranges can be expressed herein as from one value (first value) to another value (second value). When such a range is expressed, the range includes in some aspects one or both of the first value and the second value Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

It is to be understood that the terminology used herein is for the purpose of describing particular aspects only and is not intended to be limiting. As used in the specification and in the claims, the term “comprising” can include the embodiments “consisting of” and “consisting essentially of.” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used herein, the terms “about” and “at or about” mean that the amount or value in question can be the designated value, approximately the designated value, or about the same as the designated value. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

While typical aspects have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

It will be apparent to those skilled in the art that various modifications and variations can be made in the present disclosure without departing from the scope or spirit of the disclosure. Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A coating composition comprising:
exfoliated boron nitride nano sheets; and
a thermoplastic polymer matrix, wherein the coating composition:
(i) has a thermal conductivity greater than or equal to 1.0 W/mK;
(ii) has an electric breakdown voltage greater than or equal to 20 kV/mm; and
(iii) is pliable.

2. The coating composition according to claim 1, wherein the exfoliated boron nitride nano sheets are in a concentration in the range of about 1% to about 25% by volume of the coating composition.

3. The coating composition according to claim 1, further comprising a plurality of co-particles, wherein a first edge of the exfoliated boron nitride nano sheets are bound to the surfaces of the co-particles.

4. The coating composition according to claim 3, wherein the co-particles are selected from the group consisting of boron nitride BN, boron carbide B₄C, aluminum nitride AlN, aluminum oxide Al₂O₃, silicon dioxide SiO₂, magnesium oxide MgO, silicon carbide SiC, silicon nitride Si₃N₄, zinc oxide ZnO, beryllium oxide BeO, diamond, metal oxides, titanium oxide, quartz, ceramics, and combinations thereof.

5. The composition according to claim 3, wherein the co-particles are BN.

6. The composition according to claim 3, wherein the co-particles are in a concentration in the range of about 1% to about 20% by volume of the coating composition.

7. The composition according to claim 1, wherein the thermoplastic polymer is thermally stable up to a temperature of 180° C.

8. The composition according to claim 7, wherein the thermoplastic polymer is polyester imide.

9. The composition according to claim 1, wherein the thermoplastic polymer is thermally stable up to a temperature of 200° C.

10. The composition according to claim 9, wherein the thermoplastic polymer is polyamide-imide, polysulfones, or combinations thereof.

11. The composition according to claim 1, wherein the thermoplastic polymer is thermally stable at a temperature greater than or equal to 240° C.

12. The composition according to claim 11, wherein the thermoplastic polymer is a polyimide or a polyether ketone.

13. The composition according to claim 1, wherein the coating composition is coated onto an electromagnetic wire.

14. The composition according to claim 1, wherein the exfoliated boron nitride nano sheets have an average thickness of less 10 molecular layers and an aspect ratio greater than 350.

15. A method of forming a coating composition comprising:
forming exfoliated boron nitride nano sheets;
combining a first monomer and a second monomer to form a thermoplastic polymer matrix; and
causing or allowing the exfoliated boron nitride nano sheets to be dispersed throughout the thermoplastic polymer matrix, wherein the coating composition:
(i) has a thermal conductivity greater than or equal to 1.0 W/mK;
(ii) has an electric breakdown voltage greater than or equal to 20 kV/mm; and
(iii) is pliable.

16. The method according to claim 15, further comprising oxidizing the surface of boron nitride powder prior to the step of forming the exfoliated boron nitride nano sheets.

17. The method according to claim 16, further comprising:
adding the surface oxidized boron nitride powder to the first monomer and a solvent;
then exfoliating the boron nitride nano sheets and performing a silane treatment on the exfoliated boron nitride nano sheets and first monomer;
and then combining the second monomer with the exfoliated boron nitride nano sheets and first monomer.

18. The method according to claim 17, further comprising adding a plurality of co-particles after the step of combining the second monomer with the exfoliated boron nitride nano sheets and first monomer, and allowing the exfoliated boron nitride nano sheets to bond to the surfaces of the plurality of co-particles to form a filler.

19. The method according to claim 15, further comprising adding a plurality of co-particles before the step of combining the second monomer with first monomer, and allowing the exfoliated boron nitride nano sheets to bond to the surfaces of the plurality of co-particles to form a filler.

20. The method according to claim 15, further comprising dip coating the coating composition onto an electromagnetic wire.

21. (canceled)
